(19) United States
(12) Patent Application Publication
(10) Pub. No.: US 2014/0025571 A1
(43) Pub. Date: Jan. 23, 2014

(54) SYSTEM AND METHOD FOR DUAL MESSAGE CONSUMER AUTHENTICATION VALUE-BASED EFT TRANSACTIONS

(71) Applicants: Terry DOOLEY, West Des Moines, IA (US); Manish NATHWANI, Johnston, IA (US); Stephan THOMASEE, Johnston, IA (US); Scott DOBESH, Clive, IA (US)

(72) Inventors: Terry DOOLEY, West Des Moines, IA (US); Manish NATHWANI, Johnston, IA (US); Stephan THOMASEE, Johnston, IA (US); Scott DOBESH, Clive, IA (US)

(73) Assignee: ITS, Inc., Johnston, IA (US)

(21) Appl. No.: 13/555,963

(22) Filed: Jul. 23, 2012

(51) Int. Cl. G06Q 20/10; G06Q 20/14

(52) U.S. Cl. 705/40; 705/44

(57) ABSTRACT

A system and method for processing funds transfers that may utilize a dual-message transaction with separate authorization and settlement messages for (consumer authentication value) CAV-based transactions. Initial authorization messages may be communicated to authorize and guarantee funds to a payee for goods and/or services before they are rendered. Thereafter, the payee may initiate one or more settlement advice request messages associated with the authorization/pre-authorization, as goods and/or services are rendered without authorization of CAV.

### FIELD OF THE INVENTION

The invention relates generally to processing payment transactions and in particular to processing consumer authentication value (CAV) based electronic fund transfer (EFT) transactions with dual message capabilities.

### BACKGROUND OF THE INVENTION

Traditional Personal Identification Number (“PIN”)-based debit transactions are limited to a single message that authenticates and initiates movement of funds when processing a transaction between a consumer and a merchant. For example, using conventional PIN-based debit card transactions, after reading a debit card and receiving a PIN from the debit cardholder, a single message may be generated to request the funds transfer.

The single message includes a request to transfer an amount of funds from the debit card account. Upon approval, the approved amount of funds is transferred with no further messaging capabilities and the PIN is deleted for security purposes. Thus, upon approval, the approved amount of funds is transferred and the transaction is closed. As such, conventional PIN-based payments require PIN entry each time a transfer of funds is requested, transfers the entire approved amount upon approval, and offers little flexibility such as partial transfers of the approved amount.

The types of merchants or other payees who participate in such a transaction are therefore limited to those who render goods or services at the time of the transaction or otherwise receive only the amount of payment that is pre-authorized. This can be problematic in a number of contexts.

For example, using a PIN-based debit card, a restaurant may be unable to pre-authorize an amount greater than the dining bill in order to account for potential tips. This is because conventional PIN-based single message transactions would cause the entire pre-authorization amount to be transferred upon approval. In another context, an online retailer cannot pre-authorize a total amount due for a sale transaction having multiple items that may ship separately and incrementally charge their customer only after each item ships because the total amount due would have been transferred upon approval.

Conventional single message PIN-based systems also are limited to four-digit PINs for authentication. Other types of predefined secrets are typically not used, reducing scalability and flexibility for offering additional types of additional security. Conventional systems suffer from these and other problems.

### SUMMARY OF THE INVENTION

According to various implementations of the invention, various systems and methods may address these and other drawbacks of existing systems. According to various implementations of the invention, various systems and methods may process funds transfers by incorporating a consumer authentication value (CAV), such as cardholder PIN (personal identification number) or other consumer-specific secret information. The systems and methods may process the funds transfers by receiving a first authorization request comprising an encrypted CAV and a total amount of funds to be transferred. For example, the first authorization request may have originated from a merchant who swiped a payment card, received a PIN, and communicated a request to authorize a total amount. A second authorization request associated with the merchant originated first request may be generated and communicated to an issuing bank, for example, that issued the payment card. The second authorization request may include the encrypted CAV and the total amount of funds to be transferred. An authorization approval response may be received (from the issuing bank, for example) that indicates that the total amount of funds to be transferred is authorized. A unique data element that is uniquely associated with the authorization approval response may be generated. In some implementations, the unique data element may include an alphanumeric string, a digital certificate, a binary file, and/or other data that can uniquely identify an authorization. In some implementations, the unique data element indicates that the total amount has been authorized. The unique data element may be communicated to, for example, the merchant. The merchant may use the unique data element to generate one or more settlement advice request messages that each request a transfer of a portion of the total pre-authorized amount.

The one or more settlement advice request messages, which may include the unique data element and a request to transfer a portion of the total amount, may be received. In some implementations, a determination may be made regarding whether the unique data element included in the settlement advice request message(s) matches the unique data element included in the first authorization approval response. In these implementations, in response to a match, transferring the portion of the total amount may be initiated without authorization with the CAV. In other words, in some implementations, the CAV is used only to pre-authorize a total amount. The pre-authorization does not cause transfer of funds but instead may cause a hold on the funds. In these implementations, the unique data element is used to authenticate subsequent settlement advice request messages that actually cause portions less than the total pre-authorized amount to be transferred.

Thus, multiple settlement advice request messages may be generated for portions of the total amount. Each portion of the total amount associated with the corresponding settlement advice request(s) may be transferred individually without authorization using the CAV. In other words, the CAV may be authenticated during the authorization/pre-authorization phase. Thereafter, the CAV (which includes sensitive information) need not be communicated again when the settlement(s) advice requests are initiated, communicated, and processed. Instead, the unique data element is included in the settlement advice(s) for authorization purposes.

In some implementations, by using a dual message format (one type of message for pre-authorizing and another type of message for settlement advice requests) for CAV-based transactions, the system may leverage the added security provided by CAV-based authentication without having the CAV communicated multiple times amongst the relevant entities for purposes of settlement.

Other objects and advantages of the invention will be apparent to those skilled in the art based on the following drawings and detailed description.

### BRIEF DESCRIPTION OF THE DRAWINGS

FIG. 1 is a block diagram illustrating an example of a system for processing dual message CAV-based funds transfers, according to various implementations of the invention.

FIG. 2 is a data flow diagram illustrating exemplary process relationships in a system for processing dual message CAV-based funds transfers, according to various implementations of the invention.

FIG. 3 is a flow diagram illustrating an example of a process for processing dual message CAV-based funds transfers, according to various implementations of the invention.

### DETAILED DESCRIPTION

According to various implementations of the invention, various systems and methods for processing funds transfers may utilize a dual-message transaction with separate authorization and settlement messages for consumer authentication value (CAV) based transactions. Example transactions using a CAV-authenticated authorization and separate settlement advice request messages may include, but not be limited to, purchase transactions, partial fulfillment transactions, cash advance transactions, bill pay transactions, recurring payments transactions, consumer funding transactions, business funding transactions, business payment transactions, consumer payment transactions, travel and entertainment payment transactions, and/or other payment transactions that use a CAV to authenticate a pre-authorization amount that is not transferred until a subsequent settlement advice request message that does not use the CAV is received.

A consumer may include a person or other entity that requests goods and/or services from a merchant (used interchangeably with “payee”), is a cardholder, or otherwise wishes to transfer funds from an account of the consumer to another account. A merchant may include a person or other entity that requests a funds transfer (for example, a payment) associated with the goods and/or services and renders the goods and/or services to the consumer, or otherwise wishes to receive a transfer of funds from the consumer. A financial institution may include a bank such as a payment card issuing bank or other entity that provides the requested funds to the merchant.

A consumer authentication value (CAV) may include data kept private by the consumer or cardholder. In some implementations, the CAV may include a PIN (personal identification number) or other data such as an alphanumeric password, digital certificate, etc. In some implementations, the CAV need not be dependent on the attributes physically encoded or embossed on a card/device (for example, credit card, debit card, etc.), nor on any dynamic value generated as part of the transaction by a chip or a computer.

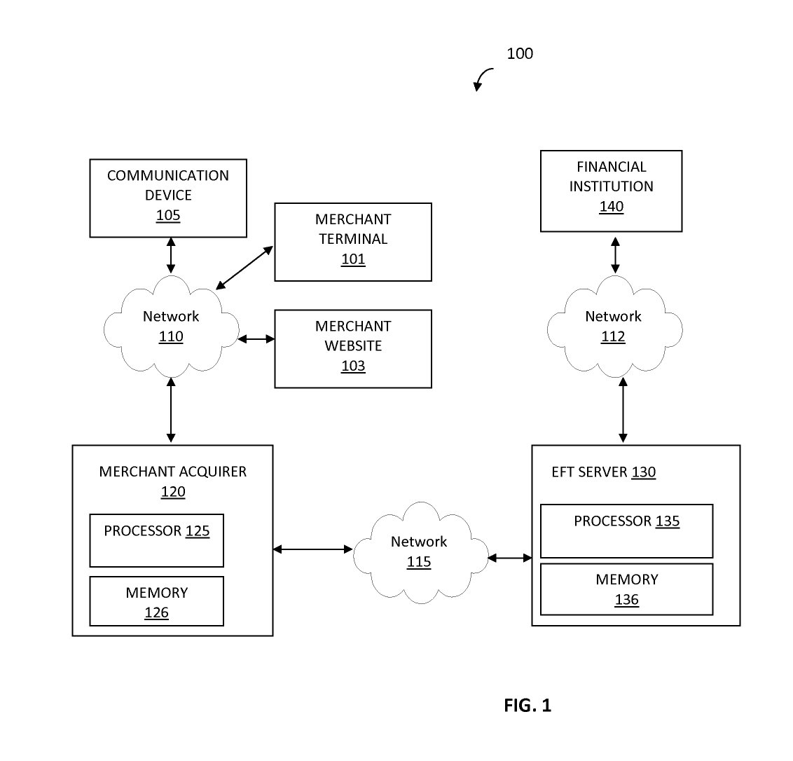

FIG. 1 is a block diagram illustrating an example of a system 100 for processing funds transfers according to various implementations of the invention. System 100 may include, for example, a merchant terminal device 101, a merchant server 103, a communication device 105, a merchant acquirer 120, a network 110, a network 115, a network 112, an EFT server 130, and a financial institution 140.

According to various implementations of the invention, a consumer may request goods and/or services from a merchant or otherwise wish to transfer funds to the merchant. In some implementations, the consumer may visit a brick-and-mortar location of the merchant. In these implementations, the consumer may present a payment card or other device used for payments, where merchant terminal 101 may be used to prompt for and receive the CAV and obtain account identification information (e.g., credit card number) from the payment card such as by swiping the card, using near-field technology, etc.

In some implementations, using communication device 105 the consumer may visit an online “virtual” store of the merchant such as a merchant website 103. In these implementations, the consumer may input the financial account identification information and CAV using a key pad or other input mechanism of communication device 105. According to various implementations of the invention, examples of communication device 105 may include any one or more of, for instance, a personal computer, portable computer, personal digital assistant (PDA), workstation, web-enabled mobile telephone, WAP device, web-to-voice device, or other device. In other words, communication device 105 may include a data (or Internet) function configured to communicate data via network 110.

In some implementations, the consumer may wish to provide a funds transfer to the merchant without buying goods/services. In these implementations, the merchant may include an individual, a charitable organization, or other entity to which the consumer would like to transfer funds and the payment may be handled by a third party (not illustrated in FIG. 1).

In some implementations, the merchant terminal 101, merchant website 103, or third party may generate a request to process a total amount of funds to be transferred and the CAV. In some implementations, the request is communicated via network 110 to merchant acquirer 120 for determining whether the total amount of funds is approved and for processing subsequent funds transfers associated with the authorization request.

In some implementations of the invention, merchant acquirer 120 may be associated with the merchant. In these implementations, merchant acquirer 120 may request and receive the funds transfer on behalf of the merchant. For example, merchant acquirer 120 may include an acquiring bank that interfaces with various payment networks, such as EFT server 130, on behalf of the merchant in order to receive funds from financial institution 140, which may include an issuing bank of a payment card account or other financial account.

In response to the request by the merchant or third party, merchant acquirer 120 may communicate an authorization request to EFT server 130. In some implementations, if the CAV is not already encrypted, merchant acquirer 120 may encrypt the CAV prior to communicating the authorization request. The authorization request may include the encrypted CAV, a total amount of funds to be transferred, and/or other information associated with the request by the merchant.

According to various implementations of the invention, EFT server 130 may receive the authorization request. According to various implementations of the invention, the encrypted CAV received in the authorization request is authenticated by the EFT server 130. EFT server 130 may decrypt the CAV and determine whether the decrypted CAV is authentic via well known authentication techniques. In some implementations where financial institution 140 authenticates the CAV, EFT server 130 would only re-encrypt the CAV and pass it along to financial institution 140.

In response to a determination that the CAV is authentic, EFT server 130 may re-encrypt the CAV and include the encrypted CAV in a second authorization request to the financial institution 140. In some implementations, if EFT server 130 validates the CAV, the CAV will not be re-encrypted and not be passed to financial institution 140. In some implementations, the second authorization request may include the encrypted CAV and the total amount of funds to be transferred. In some implementations, the second authorization request may include a request to pre-authorize the total amount of funds and hold the funds (for example, hold the funds associated with total amount in the bank or other financial account of the consumer).

In some implementations, the financial institution 140 may determine the encrypted CAV included in the second authorization request is authentic. In response to a determination that the CAV is authentic, financial institution 140 may communicate an authorization approval response to EFT server 130, provided that the total amount can be transferred from the associated financial account. In some implementations, financial institution 140 does not transfer the total amount of funds but instead places a hold on the corresponding financial account.

According to various implementations of the invention, EFT server 130 may receive an authorization approval response that indicates that the total amount of funds to be transferred is authorized/approved. In some implementations, EFT server 130 may receive the authorization approval response from financial institution 140.

According to various implementations of the invention, in response to the—authorization approval response, EFT server 130 may generate unique data element. The unique data element may comprise a pre-defined secret, private key or other attribute that is uniquely associated with the authorization approval response. In some implementations, the unique data element may provide an indication that the total amount has been authorized. In this manner, the unique data element may be used in subsequent communications with EFT server 130 to indicate approval of the total amount without another authorization process using the CAV.

In some implementations, EFT server 130 may communicate to merchant acquirer 120 an indication that the total amount has been authorized. In some implementations, the indication may include the unique data element, the authorization approval response, and/or other indications that the total amount has been authorized.

In some implementations, merchant acquirer 120 may communicate the approval indication from EFT network 130 to the merchant (via, for example, merchant terminal 101, merchant website 103, or the third party). In some implementations, the merchant retains the unique data element in order provide proof or indication that the total amount has already been authorized.

In some implementations, when the merchant wishes to receive a portion of the total amount that was pre-authorized, the merchant may request portions of the total amount to be transferred. Instead of providing a CAV for authentication, the merchant may provide the unique data element. For example, the merchant may communicate a request to merchant acquirer 120 to receive a funds transfer for a portion of the total amount, where the request includes an indication of the portion desired and the unique data element.

In this manner, the merchant may receive a portion of the pre-authorized total amount without having to again provide the CAV (which may no longer be possible because the consumer is no longer present). For example, the merchant may include a restaurant that used a consumer-provided CAV to pre-authorize a total amount of funds in the amount of $100 for a dinner bill of $70. After receiving an authorization approval and unique data element, the restaurant may request, without again having to use the CAV, a funds transfer of $85, which includes tip. The restaurant may also provide two separate subsequent requests, one for $70 and another for $15, both of which are portions of the total pre-authorized amount. In this example, two different funds transfers will occur without re-entering a CAV while both have been pre-authorized with the CAV. Similarly, in another example, the merchant can include an online retailer that pre-authorized a total amount but requests portions of the total amount as various items actually ship at different times.

According to various implementations of the invention, in response to the request(s) by the merchant, merchant acquirer 120 may generate and communicate one or more settlement advice request messages to initiate movement of funds (i.e., movement of fund that were put on hold) from the financial institution 140 to the merchant. In some implementations, the merchant may generate the settlement advice request message(s) and communicate the messages to merchant acquirer 120. In some implementations, merchant acquirer 120 may communicate the settlement advice request message(s) to EFT server 130. In these implementations, the settlement advice request message(s) may be received by EFT server 130.

According to various implementations of the invention, settlement advice request message(s) may be associated with the authorization approval response, wherein each settlement advice request message may include a request to transfer a portion of the authorized total amount indicated by the authorization approval response. In some implementations, each settlement advice request message may include the unique data element and the requested transfer amount.

According to various implementations of the invention, EFT server 130 may process each received settlement advice request message. EFT server 130 may retrieve the unique data element included in the settlement advice request message and compare it with the unique data element that was previously generated by EFT server 130 (i.e., the unique data element that was uniquely associated with the authorization approval response and that was previously communicated to merchant acquirer 120 by EFT server 130). In response to a match, EFT server 130 may determine that the settlement advice request message is associated with the second authorization request/authorization approval response. In other words, EFT server 130 may determine that the settlement advice is associated with the original authorization/pre-authorization. In response to a determination that there is no match, the advice request message will be denied and no transfer of funds will occur.

According to various implementations of the invention, EFT server 130 may communicate the settlement advice request message to the financial institution 140. In response, the financial institution 140 may debit the corresponding financial account and transfer (i.e., credit) the portion of the total amount associated with the settlement advice request message to merchant acquirer 120 without again authenticating the CAV. Thereafter, in some implementations, merchant acquirer 120 may cause the portion of funds to be transferred to the merchant. For example, merchant acquirer 120 may cause the portion of funds to be transferred to an account of the merchant, which may be serviced by merchant acquirer 120 or other entity/financial institution.

According to various implementations of the invention, the CAV is authenticated and communicated during the initial authorization/pre-authorization for a specified total amount. Subsequently, the unique data element(s) generated by the EFT server 130 and included in the settlement advice request message(s) are used for purposes of authorizing the movement of funds between the financial institution 140 and the merchant. Thus, sensitive information, for example, the CAV need not be communicated again between the various entities for settlement of transactions (e.g., consumer, payee/merchant acquirer 120, EFT server 130, and financial institution 140). Not only does this provide enhanced security, but also allows the merchant to receive the CAV from the consumer once for a particular transaction and receive subsequent payments (i.e., funds transfers) that can be portions of the total amount associated with the particular transaction without the consumer being present or otherwise again inputting the CAV.

In some implementations, EFT server 130 may associate settlement advice request messages with the unique data element and total amount that was pre-authorized in order to determine whether a sum of the portions requested in the settlement advice request messages exceeds the total amount that was pre-authorized. In some implementations, EFT server 130 may initiate a funds transfer when the portion requested by a settlement advice request message, when summed with prior settlement advice request messages associated with the unique data element, does not exceed the total amount. In some implementations, EFT server 130 may perform exception handling when a portion to be transferred when summed with other portions already transferred exceeds the total amount that was pre-authorized. The EFT server 130 may approve or decline such settlement advice requests based on EFT network processing rules between the merchant and EFT server 130 and between EFT server 130 and financial institution 140.

By providing separate authorization requests and settlement advice request messages, CAV-based transactions may be facilitated at any merchant site (e.g., eCommerce or “brick-and-mortar”). Funds availability may be guaranteed to the merchant before goods and services are rendered. Thereafter, the consumer may initiate one or more settlement advice request messages associated with the authorization/pre-authorization as goods and/or services are rendered.

According to various implementations of the invention, merchant acquirer 120, EFT server 130, and/or financial institution 140 may encrypt the CAV. In some implementations, a Triple Data Encryption Algorithm (commonly, “Triple DES”) may be applied to encrypt/decrypt the CAV. As would be appreciated by those having skill in the art, other encryption algorithms may be utilized.

In some implementations, a database (not illustrated in FIG. 1) may include consumer information, such as, for example, credit card numbers, debit card numbers, consumer contact information, an identity of communication device 105 used by the consumer, and/or other information. In some implementations, the database may store the transaction related data elements including the unique data element for later retrieval by merchant acquirer 120, EFT server 130, and/or financial institution 140. According to various implementations of the invention, examples of the database, include, for instance, a relational database, a filesystem, and/or other device or data representation configured for data storage.

EFT server 130 may perform EFT transactions involving funds transfer via EFT messages. The EFT messages could be in the form of ISO 8583 payment messages supported by various EFT networks. Each network adapts the ISO 8583 standard for its own use with custom fields and custom usages. The placement of fields in different versions such as 1987, 1993 and 2003 of the standard varies. Also, one EFT network may act as a gateway to other EFT networks to provide universal coverage.

In some implementations, EFT server 130 may receive the consumer's bank account information from the financial institution 140. In some implementations, EFT server 130 may acquire the payee's account information from merchant acquirer 120. In some implementations, the database may include the payee's account information and EFT server 130 may retrieve the payee's account information from the database.

In some implementations, EFT server 130 may debit the portion of the total amount from the consumer's bank account. In some implementations, EFT server 130 may credit the portion of the total amount to the payee's account.

In some implementations, EFT server 130 may generate a receipt for the consumer and the payee. The receipt may include, among other information, an amount of fund transfer (i.e., portion of total amount credited to payee account or debited from consumer account), date the transfer was credited/debited, the type of transfer and type of account (i.e., checking, savings, or other account) to which funds were transferred, the name of payee to whom funds were transferred, or the name of consumer from whom funds were transferred, consumer/payee account number, and/or any fees assessed against the consumer/payee account for the fund transfer. In some implementations, EFT server 130 may communicate the receipt to communication device 105 or merchant acquirer 120 via email, text messages, or other communication mechanisms. The consumer may view the receipt via communication device 105.

According to various implementations of the invention, merchant acquirer 120 may communicate with communication device 105 on a communication channel via network 110. Merchant acquirer 120 may communicate with EFT server 130 on a communication channel via network 115. EFT server 130 may communicate with financial institution 140 on a communication channel via network 112. Network 110, 112, or 115 may be a Public Switch Telephone Network (PSTN), VoIP network, and/or other network or combination of networks that is configured for electronic communications (voice and data).

In some implementations, merchant acquirer 120 may include a processor 125, a memory 126, and/or other components that facilitate the functions of merchant acquirer 120. In some implementations, processor 125 includes one or more processors configured to perform various functions of merchant acquirer 120. In some implementations, memory 126 includes one or more tangible (i.e., non-transitory) computer readable media. Memory 126 may include one or more instructions that when executed by processor 125 configure processor 125 to perform functions of merchant acquirer 120. In some implementations, memory 126 may include one or more instructions stored on tangible computer readable media that when executed at a remote device, such as communication device 105, or EFT server 130 cause the remote device to facilitate interaction with payee processing server, as described herein.

In some implementations, EFT server 130 may include a processor 135, a memory 136, and/or other components that facilitate the functions of EFT server 130. In some implementations, processor 135 includes one or more processors configured to perform various functions of EFT server 130. In some implementations, memory 136 includes one or more tangible (i.e., non-transitory) computer readable media. Memory 136 may include one or more instructions that when executed by processor 135 configure processor 135 to perform functions of EFT server 130. In some implementations, memory 136 may include one or more instructions stored on tangible computer readable media that when executed at a remote device, such as merchant acquirer 120 or a device associated with financial institution, cause the remote device to facilitate interaction with EFT server, as described herein.

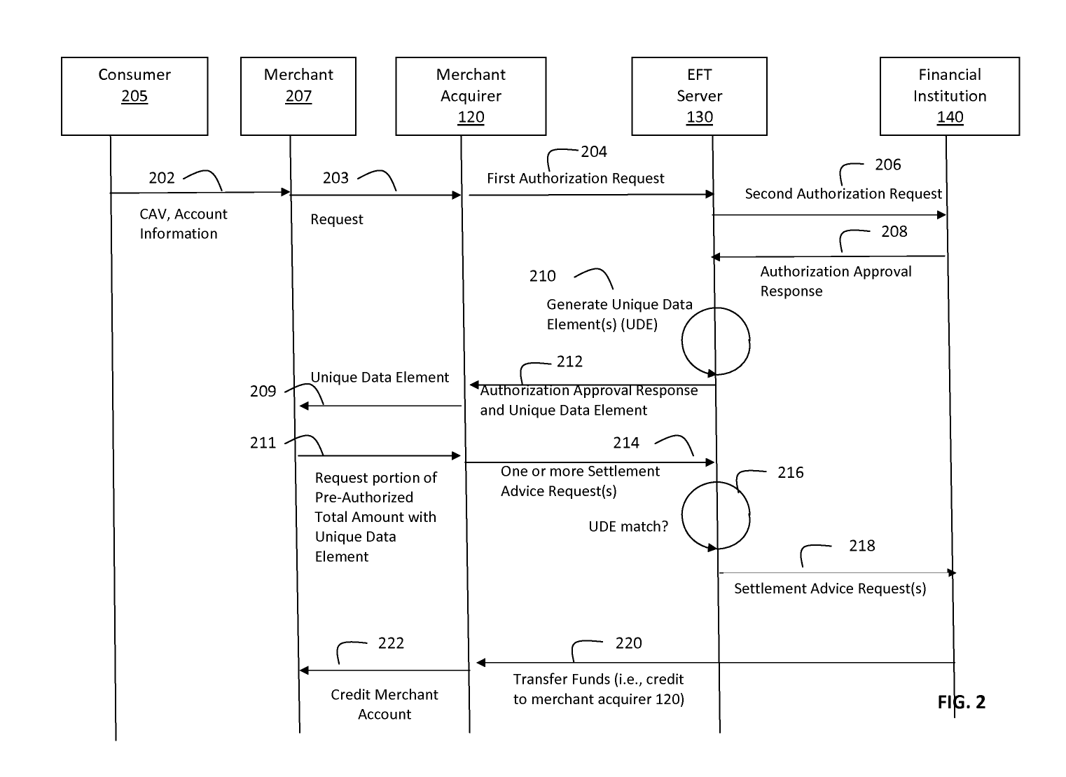

FIG. 2 is a data flow diagram illustrating exemplary process relationships in a system for processing funds transfers, according to various implementations of the invention. Consumer 205 may wish to transfer funds to merchant 207 (consumer request) and may therefore provide account information and a CAV in operation 202. For example, consumer 205 may purchase goods/services from merchant 207 or may wish to simply transfer funds to merchant 207. In order to cause the funds to be transferred, consumer 205 may provide account information such as a payment card number and input the CAV into a keypad. In some implementations, consumer 205 may request goods/services via a website associated with merchant 207. In some implementations, consumer 205 may request goods/services at a brick-and-mortar location of merchant 207.

In some implementations, merchant 207 generates a request to merchant acquirer 120 in an operation 203. For example, a merchant terminal device (such as a card reader) may communicate the account information, CAV, and amount to transfer to merchant acquirer 120. In some implementations, merchant acquirer 120 may receive the consumer request via a communication device of the consumer (such as communication device 105 illustrated in FIG. 1). In these implementations, consumer 205 may use communication device 105 to navigate an eCommerce website of merchant 207. In some implementations, consumer 205 may utilize communication device 105 to provide a CAV associated with the consumer.

In some implementations, consumer 205 may visit a payee store (e.g., a brick and mortar retail establishment associated with the payee) to request goods/services. In some implementations, consumer 205 may swipe or otherwise cause a payment card to be read at the store. In some implementations, consumer 205 may input card/account information, CAV, and/or other information in a different manner at the store such as by manually inputting the information into a keypad, using near-field devices, or using a smart chip. In some implementations, merchant 207 may utilize merchant acquirer 120 to process the consumer request.

According to various implementations of the invention, merchant acquirer 120 may generate a first authorization request and communicate the first authorization request to EFT server 130 in operation 204. In some implementations, merchant acquirer 120 may encrypt the CAV obtained from the consumer and include the encrypted CAV in the first authorization request. In some implementations, the first authorization request may include, among other things, a transaction identifier, the encrypted CAV, and the total amount of funds to be transferred based on the total payment amount associated with the consumer request.

According to various implementations of the invention, EFT server 130 may generate a second authorization request based on the received first authorization request in operation 206. EFT server 130 may communicate the second authorization request to the financial institution 140.

In some implementations, EFT server 130 may retrieve the encrypted CAV from the first authorization request. EFT server 130 may decrypt the CAV and determine whether the decrypted CAV is authentic. In response to a determination that the CAV is authentic, EFT server 130 may generate the second authorization request. EFT server 130 may encrypt the CAV and include the encrypted CAV in the second authorization request. In some implementations, the second authorization request may include, among other things, the encrypted CAV, the total amount of funds to be transferred (from the first authorization request 204), and the transaction identifier.

In some implementations, in response to a determination that the CAV is not authentic, the first authorization request message will be denied.

According to various implementations of the invention, financial institution 140 may generate an authorization approval response based on the second authorization request and communicate the authorization approval response back to EFT server 130 in operation 208. In some implementations, the authorization approval response may indicate that the total amount of funds to be transferred is authorized.

In some implementations, the financial institution 140 may retrieve the encrypted CAV from the second authorization request. The financial institution 140 may decrypt the CAV and determine whether the decrypted CAV is authentic. In response to a determination that the CAV is authentic, financial institution 140 may determine whether the bank account associated with the consumer has sufficient funds to cover the total amount included in the second authorization request. In response to a determination that the bank account has sufficient funds, the financial institution 140 may generate the authorization approval response, which indicates that the total amount of funds to be transferred is authorized, and may put a hold on the authorized funds. In response to a determination that the bank account does not have sufficient funds, financial institution 140 may decline the request and communicate a message to that effect.

In some implementations, the authorization approval response from financial institution 140 may include, among other things, the transaction identifier and the authorized total amount of funds to be transferred.

In some implementations, in response to the authorization approval response received from financial institution 140, EFT server 130 may generate unique data element that is uniquely associated with the received authorization approval response in operation 210. In some implementations, the unique data element may include a pre-defined secret, a private key, or other unique attribute.

In some implementations, the unique data element and the authorization approval response is communicated by EFT server 130 to merchant acquirer 120 in operation 212. In some implementations, the unique data element provides an indication that the total amount of funds to be transferred has been authorized.

In some implementations, merchant acquirer 120 may communicate the unique data element to merchant 207 in an operation 209. In operation 209, merchant 207 is notified of the pre-authorization of the total amount of funds.

In some implementations, merchant 207 may, after receiving the pre-authorization indication, request to have transferred a portion of the pre-authorized total amount in an operation 209. For example, merchant 207 may ship out a portion of a purchase and wish to be paid for that portion. In this example, the remaining purchase may have yet to ship and as a service the merchant may not wish to receive funds from consumer 205 until the remaining purchase items are shipped. In operation 209, the merchant may provide the portion of funds he would like transferred and the unique data element as proof that the portion should be authorized based on the authorized approval identified by the unique data element. In some implementations, the request is in the form of a settlement advice request message, which indicates the portion to be transferred and includes the unique data element.

According to various implementations of the invention, in response to the merchant request, merchant acquirer 120 may generate and/or communicate a settlement advice request message to EFT server 130 in operation 214. Each settlement advice may include, among other things, the transaction identifier, the unique data element that was communicated to the merchant acquirer 120 by EFT server 130, and a request to transfer a portion of the total amount of funds to be transferred.

In some implementations, EFT server 130 may identify the authorization request(s), or authorization approval response that each settlement advice request is associated with based on the transaction identifier. In other words, EFT server 130 may determine whether the settlement advice request has a corresponding authorization request or authorization approval response based on the transaction identifier. In response to a determination that the settlement advice request(s) does have a corresponding authorization request or authorization approval response, EFT server 130 may compare (in operation 216) the unique data element included in the settlement advice request(s) with the unique data element previously generated by the EFT server 130 (i.e., the unique data element that was uniquely associated with the authorization approval response and that was communicated to merchant acquirer 120 by EFT server 130). In response to a match, EFT server 130 may communicate the settlement advice request to financial institution 140 (in operation 218) to initiate movement of funds from the financial institution 140 to merchant acquirer 120.

In response to a determination that there is no match, EFT server 130 may provide an exception message to merchant acquirer 120 that the unique data element provided is not associated with a corresponding pre-authorized approval amount.

According to various implementations of the invention, in operation 220, financial institution 140 may process the settlement advice request and initiate a transfer of the associated portion of the total amount to merchant acquirer 120 without authorization with the CAV. In some implementations, merchant acquirer 120 may render transfer of the associated portion to merchant 207 such as by causing a credit to an account of merchant 207 in an operation 222.

For example, merchant acquirer 120 may generate a first authorization request including an encrypted CAV and a total amount of 100 dollars to be transferred. Merchant acquirer 120 may communicate the first authorization request to EFT server 130. EFT server 130 may generate a second authorization request associated with the first authorization request. The second authorization request may include the encrypted CAV and the total amount of 100 dollars to be transferred. Financial institution 140 may receive the second authorization request and may determine that the consumer's bank account has sufficient funds to cover the total amount of 100 dollars. Financial institution 140 may generate and communicate an authorization approval response to the EFT server 130 indicating that the total amount of 100 dollars is authorized. EFT server 130 may communicate the approval response/unique data element to merchant acquirer 120.

Subsequently, merchant acquirer 120 may generate a first settlement advice request comprising the unique data element and a request to transfer a first amount of the total amount (for example, 50 dollars of the 100 dollars—based on a first portion of the goods/services to be/being rendered to the consumer). EFT server 130 may receive the first settlement advice request and determine whether the unique data element included in the advice matches the unique data element included in the approved authorization response. In response to a match, EFT server 130 may communicate the first settlement advice request to the financial institution 140 to initiate the transfer of the first amount without CAV authentication. Financial institution 140 may transfer the first amount from the consumer's bank account (i.e., the funds there were put on hold in the consumer's bank account) to the payee.

Thereafter, merchant acquirer 120 may generate a second settlement advice request comprising the unique data element and a request to transfer the a second amount of the total amount (for example, the other 50 dollars of the 100 dollars—based on a second portion of the goods/services to be/being rendered to the consumer). EFT server 130 may receive the second settlement advice request and determine whether the unique data element included in the advice matches the unique data element included in the approved authorization response. In response to a match, EFT server 130 may communicate the second settlement advice request to the financial institution 140 to initiate the transfer of the second amount without authorization with the CAV. Financial institution 140 may transfer the second amount from the consumer's bank account (i.e., the funds there were put on hold in the consumer's bank account) to the payee.

In some implementations, EFT server 130 may determine whether a sum of the first amount and the second amount is greater than the total amount prior to communicating the settlement advice request to the financial institution 140. For example, the first settlement advice request may include a first amount of 50 dollars and the second settlement advice request may include a second amount of 60 dollars, totaling to 110 dollars which is greater than the authorized 100 dollars. In response to a determination that the sum is greater than the total amount, the EFT Server 130 may approve or decline such settlement advice requests based on EFT network processing rules between the merchant and EFT server 130 and between EFT server 130 and financial institution 140.

In some implementations, EFT server 130 may determine whether a sum of the first amount and the second amount is lesser than the total amount prior to communicating the settlement advice request to the financial institution 140. For example, the first settlement advice request may include a first amount of 50 dollars and the second settlement advice request may include a second amount of 40 dollars, totaling to 90 dollars which is lesser than the authorized 100 dollars. In response to a determination that the sum is lesser than the total amount, the EFT server 130 may eventually expire any pre-authorized funds based on EFT Network processing rules.

In some implementations, for certain payment transactions, for example, travel and entertainment payment transactions, the sum of the first amount and the second amount may exceed the total amount by a variable percentage, which may be configurable or otherwise predefined. In these implementations, EFT server 130 may determine whether the sum of the first amount and the second amount is greater than the total amount in addition to the variable percentage. In response to a determination that the sum is greater than the total amount, the EFT Server 130 may approve or decline such settlement advice requests based on EFT network processing rules between the merchant and EFT server 130 and between EFT server 130 and financial institution 140. In these implementations, EFT server 130 may determine whether the sum of the first amount and the second amount is lesser than the total amount in addition to the variable percentage. In response to a determination that the sum is lesser than the total amount, EFT server 130 may approve the transaction.

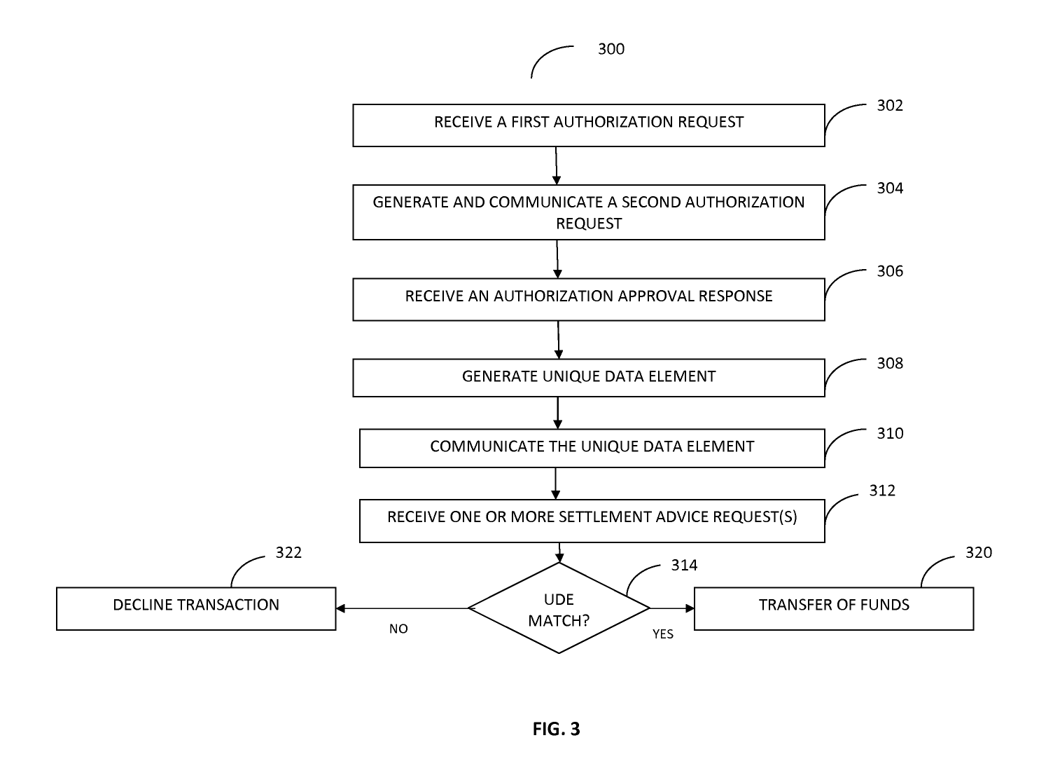

FIG. 3 is a flow diagram illustrating an example process 300 of processing electronic funds transfers according to various implementations of the invention. The various processing operations depicted in the flow diagram of FIG. 3 (and in the other drawing figures) are described in greater detail herein. The described operations for a flow diagram may be accomplished using some or all of the system components described in detail above and, in some implementations, various operations may be performed in different sequences. In some implementations, additional operations may be performed along with some or all of the operations shown in the depicted flow diagrams. In yet other implementations, one or more operations may be performed simultaneously. Accordingly, the operations as illustrated (and described in greater detail below) are examples by nature and, as such, should not be viewed as limiting.

According to various implementations of the invention, in an operation 302, process 300 may receive a first authorization request. In some implementations, the authorization request may include an encrypted CAV and a total amount of funds to be transferred.

In an operation 304, process 300 may generate and communicate a second authorization request associated with the received first authorization request. In some implementations, the second authorization request may include the encrypted CAV and the total amount of funds to be transferred.

In an operation 306, process 300 may receive an authorization approval response that indicates that the total amount of funds to be transferred is authorized. In an operation 308, operation 300 may generate a unique data element. In some implementations, the unique data element may include a private key, a pre-defined secret, or other unique attribute.

In an operation 310, process 300 may communicate the unique data element. In an operation 312, process 300 may receive one or more settlement advice request messages. In some implementations, each settlement advice request message may include the unique data element and a request to transfer a portion of the total amount.

In an operation 314, process 300 may determine whether the unique data element included in the settlement advice request matches the unique data element included in the approved authorization response.

In an operation 320, in response to a match, process 300 may cause a transfer of the portion of the total amount without authorization with the CAV. In an operation 322, in response to no match, process 300 may deny the transaction indicating that no match was found.

The description above applies to processing of funds transfers for payment transactions, including purchase transactions, partial fulfillment transactions, consumer and business payment transactions. The description applies to other types of transactions as well such as a consumer wishing to transfer funds to another person or entity.

For example, for bill pay and recurring payment transactions, EFT server 130 may generate and communicate an authorization request to financial institution 140. The authorization request may be generated when a bill is to be paid by a consumer to the payee. The authorization request may be effective for a pre-determined time period. The authorization request may include an encrypted CAV associated with the consumer payee information and/or other information. The financial institution 140 may authenticate the CAV to determine consumer authenticity. The financial institution 140 may generate an authorization approval response that indicates that the consumer has been authenticated. EFT server 130 may generate at least one unique element that is uniquely associated with the authorization approval response and that provides proof that the consumer has been authenticated.

EFT server 130 may receive one or more subsequent bill pay/recurring payment financial requests. Each bill pay/recurring payment financial request may include the unique data element, payee information and a requested amount (i.e., a request to transfer a payment amount). EFT server 130 may determine whether the unique data element included in the bill pay/recurring payment financial request matches the unique data element included in the approved authorization response.

In response to a match, EFT server 130 may determine whether the pre-determined time period for which the authorization request is effective has expired. In response to a determination that the pre-determined time period has not expired, EFT server 130 generates and sends a financial request to financial institution 140 for authorization. In response to a determination that the financial request was approved by financial institution 140, based on consumer funds availability at the time of the financial request, EFT server 130 causes transfer of the amount requested in the financial request without authorization with the CAV.

Implementations of the invention may be made in hardware, firmware, software, or any suitable combination thereof. Implementations of the invention may also be implemented as instructions stored on a machine-readable medium, which may be read and executed by one or more processors. A tangible machine-readable medium may include any mechanism for storing or transmitting information in a form readable by a machine (e.g., a computing device). For example, a tangible machine-readable storage medium may include read only memory, random access memory, magnetic disk storage media, optical storage media, flash memory devices, and other tangible storage media. Intangible machine-readable transmission media may include intangible forms of propagated signals, such as carrier waves, infrared signals, digital signals, and other intangible transmission media. Further, firmware, software, routines, or instructions may be described in the above disclosure in terms of specific exemplary implementations of the invention, and performing certain actions. However, it will be apparent that such descriptions are merely for convenience and that such actions in fact result from computing devices, processors, controllers, or other devices executing the firmware, software, routines, or instructions.

Implementations of the invention may be described as including a particular feature, structure, or characteristic, but every aspect or implementation may not necessarily include the particular feature, structure, or characteristic. Further, when a particular feature, structure, or characteristic is described in connection with an aspect or implementation, it will be understood that such feature, structure, or characteristic may be included in connection with other implementations, whether or not explicitly described. Thus, various changes and modifications may be made to the provided description without departing from the scope or spirit of the invention. As such, the specification and drawings should be regarded as exemplary only, and the scope of the invention to be determined solely by the appended claims.

What is claimed is:

1. A method of processing electronic funds transfers, the method comprising:
receiving a first authorization request comprising an encrypted consumer authentication value (CAV) and a total amount of funds to be transferred;
generating and communicating a second authorization request associated with the received first authorization request, the second authorization request comprising the encrypted CAV and the total amount of funds to be transferred;
receiving an authorization approval response that indicates that the total amount of funds to be transferred is authorized;
generating a unique data element that is uniquely associated with the authorization approval response and provides an indication that the total amount has been authorized;
communicating the unique data element;
receiving a first settlement advice request message comprising the unique data element and a request to transfer a first amount of the total amount, the first amount being a portion less than the total amount;
determining whether the unique data element included in the first settlement advice request message matches the unique data element included in the approved authorization response; and
in response to a match, causing the first amount of the total amount to be transferred without authorization with the CAV.

2. The method of claim 1, further comprising:
receiving a second settlement advice request message associated with the transaction, wherein the second settlement advice request message includes a second amount of the total amount and the unique data element;
determining whether the unique data element included in the second settlement advice request message matches the unique data element included in the approved authorization response; and
in response to a match, causing the second amount of the total amount to be transferred without authorization with the CAV.

3. The method of claim 2, further comprising:
determining whether a sum of the first amount and the second amount is greater than the total amount; and
in response to a determination that the sum is greater than the total amount, decline the second amount.

4. The method of claim 2, further comprising:
determining whether a sum of the first amount and the second amount is less than the total amount; and
in response to a determination that the sum is less than the total amount, causing the second amount of the total amount to be transferred without authorization with the CAV.

5. The method of claim 1, wherein the CAV is a personal identification number (PIN).

6. The method of claim 1, wherein the unique data element comprises a pre-defined secret or private key.

7. A system of processing funds transfers, the system comprising:
an electronic funds transfer server comprising one or more processors configured to:
receive a first authorization request comprising an encrypted consumer authentication value (CAV) and a total amount of funds to be transferred;
generate and communicate a second authorization request associated with the received authorization request, the second authorization request comprising the encrypted CAV and the total amount of funds to be transferred;
receive an authorization approval response that indicates that the total amount of funds to be transferred is authorized;
generate unique data element that is uniquely associated with the pre-authorization approval response and provides an indication that the total amount has been authorized;
communicate the unique data element;
receive a first settlement advice request message comprising the unique data element and a request to transfer a first amount of the total amount;
determine whether the unique data element included in the first settlement advice request message matches the unique data element included in the approved authorization response; and
in response to a match, cause the first amount of the total amount to be transferred without authorization with the CAV.

8. The system of claim 7, the one or more processors configured to:
receive a second settlement advice request message associated with the transaction, wherein the second settlement advice request message includes a second amount of the total amount and the unique data element;
determine whether the unique data element included in the second settlement advice request message matches the unique data element included in the approved authorization response; and
in response to a match, cause the second amount of the total amount to be transferred without authorization with the CAV.

9. The system of claim 8, the one or more processors configured to:
determine whether a sum of the first amount and the second amount is greater than the total amount; and
in response to a determination that the sum is greater than the total amount, decline the second amount.

10. The system of claim 8, the one or more processors configured to:
determine whether a sum of the first amount and the second amount is less than the total amount; and
in response to a determination that the sum is less than the total amount, cause the second amount of the total amount to be transferred without authorization with the CAV.

11. The system of claim 7, wherein the CAV is a personal identification number (PIN).

12. The system of claim 7, wherein the unique data element comprises a pre-defined secret or private key.

13. A method of processing electronic funds transfers, the method comprising:
generating and communicating an authorization request comprising an encrypted consumer authentication value (CAV) and a total amount of funds to be transferred;
receiving an authorization approval response that indicates that the total amount of funds to be transferred is authorized;
generating a unique data element that is uniquely associated with the authorization approval response and provides an indication that the total amount has been authorized;
communicating the unique data element;
receiving a first settlement advice request message comprising the unique data element and a request to transfer a first amount of the total amount, the first amount being a portion less than the total amount; and
causing the first amount of the total amount to be transferred without authorization with the CAV based on the unique data element, the first amount, and the total amount.

14. A method of processing electronic funds transfers associated with a bill payment transaction, the method comprising:
generating and communicating an authorization request comprising an encrypted CAV associated with a consumer;
receiving an authorization approval response that indicates that the consumer has been authenticated;
generating a unique data element that is uniquely associated with the authorization approval response and provides proof that the consumer has been authenticated;
communicating the unique data element;
receiving a first payment financial message comprising the unique data element and a request to transfer a first payment amount;
determining whether the unique data element included in the first payment financial message matches the unique data element included in the approved authorization response; and
in response to a match, causing the payment amount to be transferred without authorization with the CAV.

15. The method of claim 14, further comprising:
receiving a second payment financial message associated with the transaction, wherein the second payment financial message includes a second payment amount and the unique data element;
determining whether the unique data element included in the second payment financial message matches the unique data element included in the approved authorization response; and
in response to a match, causing the second amount to be transferred without authorization with the CAV.

16. The method of claim 14, wherein the CAV is a personal identification number (PIN).

17. The method of claim 14, wherein the unique data element comprises a pre-defined secret or private key.

18. A system of processing funds transfers associated with a bill payment transaction, the system comprising:
an electronic funds transfer server comprising one or more processors configured to:
generate and communicate an authorization request comprising an encrypted CAV associated with a consumer;
receive an authorization approval response that indicates that the consumer has been authenticated;
generate unique data element that is uniquely associated with the authorization approval response and provides proof that the consumer has been authenticated;
communicate the unique data element;
receive a first payment financial message comprising the unique data element and a request to transfer a first payment amount;
determine whether the unique data element included in the first payment financial message matches the unique data element included in the approved authorization response; and
in response to a match, cause the payment amount to be transferred without authorization with the CAV.

19. The system of claim 18, the one or more processors configured to:
receive a second payment financial message associated with the transaction, wherein the second payment financial message includes a second payment amount and the unique data element;
determine whether the unique data element included in the second payment financial message matches the unique data element included in the approved authorization response; and
in response to a match, cause the second amount to be transferred without authorization with the CAV.

20. The system of claim 18, wherein the CAV is a personal identification number (PIN).

21. The system of claim 18, wherein the unique data element comprises a pre-defined secret or private key.
